(19) United States
(12) Patent Application Publication
(10) Pub. No.: US 2013/0155237 A1
(43) Pub. Date: Jun. 20, 2013

(54) INTERACTING WITH A MOBILE DEVICE WITHIN A VEHICLE USING GESTURES

(71) Applicants: Timothy S. Paek, Sammarmish, WA (US); Paramvir Bahl, Bellevue, WA (US); Oliver H. Foehr, Bellevue, WA (US)

(72) Inventors: Timothy S. Paek, Sammarmish, WA (US); Paramvir Bahl, Bellevue, WA (US); Oliver H. Foehr, Bellevue, WA (US)

(73) Assignee: Microsoft Corporation, Redmond, WA (US)

(21) Appl. No.: 13/327,787

(22) Filed: Dec. 16, 2011

(51) Int. Cl. H04N 7/18

(52) U.S. Cl. 348/148; 348/E07.085

(57) ABSTRACT

A mobile device is described herein which includes functionality for recognizing gestures made by a user within a vehicle. The mobile device operates by receiving image information that captures a scene including objects within an interaction space. The interaction space corresponds to a volume that projects out from the mobile device in a direction of the user. The mobile device then determines, based on the image information, whether the user has performed a recognizable gesture within the interaction space, without touching the mobile device. The mobile device can receive the image information from a camera device that is an internal component of the mobile device and/or a camera device that is a component of a mount which secures the mobile device within the vehicle. In some implementations, one or more projectors provided by the mobile device and/or the mount may illuminate the interaction space.

### BACKGROUND

A user who is driving a vehicle faces many distractions. For example, a user may momentarily take his or her attention off the road to interact with a media system provided by the vehicle. Or a user may manually interact with a mobile device, e.g., to make and receive calls, read Email, conduct searches, and so on. In response to these activities, many jurisdictions have enacted laws which prevent users from manually interacting with mobile devices in their vehicles.

A user can reduce the above-described types of distractions by using various hands-free interaction devices. For example, the user can conduct a call using a headset or the like, without holding the mobile device. Yet these types of devices do not provide a general-purpose solution for the myriad distractions that may confront a user while driving.

### SUMMARY

A mobile device is described herein which includes functionality for recognizing gestures made by a user within a vehicle. The mobile device operates by receiving image information that captures a scene including objects within an interaction space. The interaction space corresponds to a volume that projects out a prescribed distance from the mobile device in a direction of the user. The mobile device then determines, based on the image information, whether the user has performed a recognizable gesture within the interaction space, without touching the mobile device. The gesture comprises one or more of: (a) a static pose made with at least one hand of the user; and (b) a dynamic movement made with said at least one hand of the user.

In some implementations, the mobile device can receive the image information from a camera device that is an internal component of the mobile device and/or a camera device that is component of a mount which secures the mobile device within the vehicle.

In some implementations, the mobile device and/or mount can include one or more projectors. The projectors illuminate the interaction space.

In some implementations, at least one camera device produces the image information in response to the receipt of infrared spectrum radiation.

In some implementations, the mobile device extracts a representation of objects within the interaction space using a depth reconstruction technique. In other implementations, the mobile device extracts a representation of objects within the interaction space by detecting objects having increased relative brightness within the image information. These objects, in turn, correspond to objects that are illuminated by one or more projectors.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative environment in which a user may interact with a mobile device using gestures, while operating a vehicle.

FIG. 2 depicts an interior region of a vehicle. The interior region includes a mobile device secured to a surface of the vehicle using a mount.

FIG. 3 shows one type of representative mount that can be used to secure the mobile device within a vehicle.

FIG. 4 shows the use of the mobile device to establish an interaction space within the vehicle.

FIG. 5 shows one illustrative implementation of a mobile device, for use in the environment of FIG. 1.

FIG. 6 shows illustrative movement sensing devices that can be used by the mobile device of FIG. 5.

FIG. 7 shows illustrative output functionality that can be used by the mobile device of FIG. 5 to present output information.

FIG. 8 shows illustrative functionality associated with the mount of FIG. 3, and the manner in which this functionality can interact with the mobile device.

FIG. 9 shows further details regarding a representative application and a gesture recognition module, which can be provided by the mobile device of FIG. 5.

FIGS. 10-19 show illustrative gestures which invoke various actions. Some of the actions may control the manner in which media content is presented to the user.

FIG. 20 shows a user interface presentation that provides prompt information and feedback information. The prompt information invites the user to make a gesture selected from a set of candidate gestures, within a particular context, while the feedback information confirms a gesture that has been recognized by the mobile device.

FIGS. 21-23 show three illustrative gestures, each of which involves a user touching his or her face in a telltale manner.

FIG. 24 shows an illustrative procedure that explains one manner of operation of the environment of FIG. 1, from the perspective of a user.

FIG. 25 shows an illustrative procedure for calibrating a mobile device for operation in a gesture-recognition mode.

FIG. 26 shows an illustrative procedure for adjusting at least one operational setting of the gesture recognition module to dynamically modify its performance.

FIG. 27 shows an illustrative procedure by which the mobile device can detect and respond to gestures.

FIG. 28 shows illustrative computing functionality that can be used to implement any aspect of the features shown in the foregoing drawings.

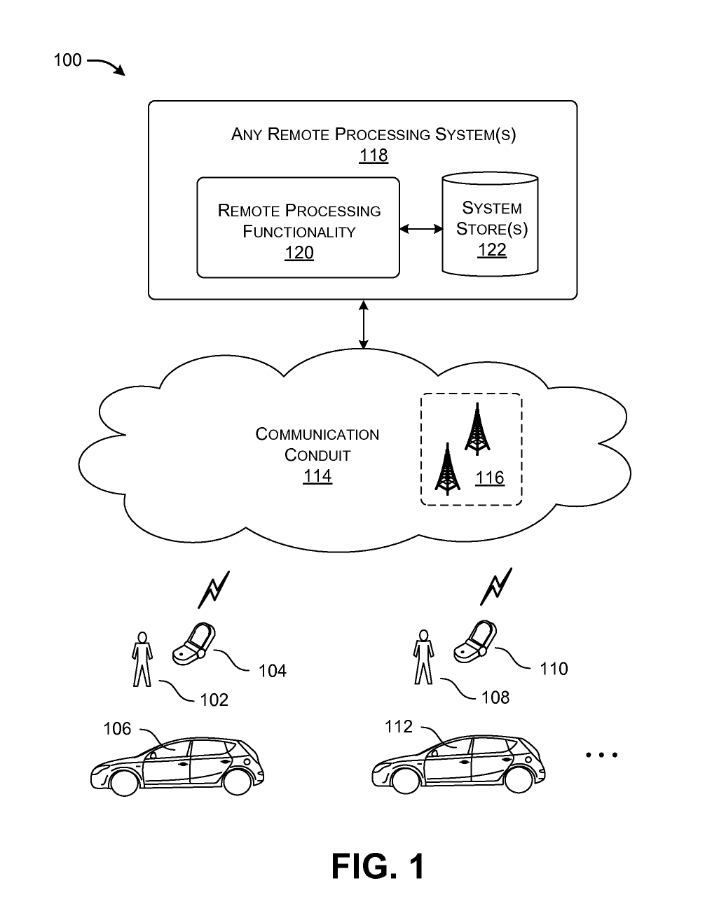

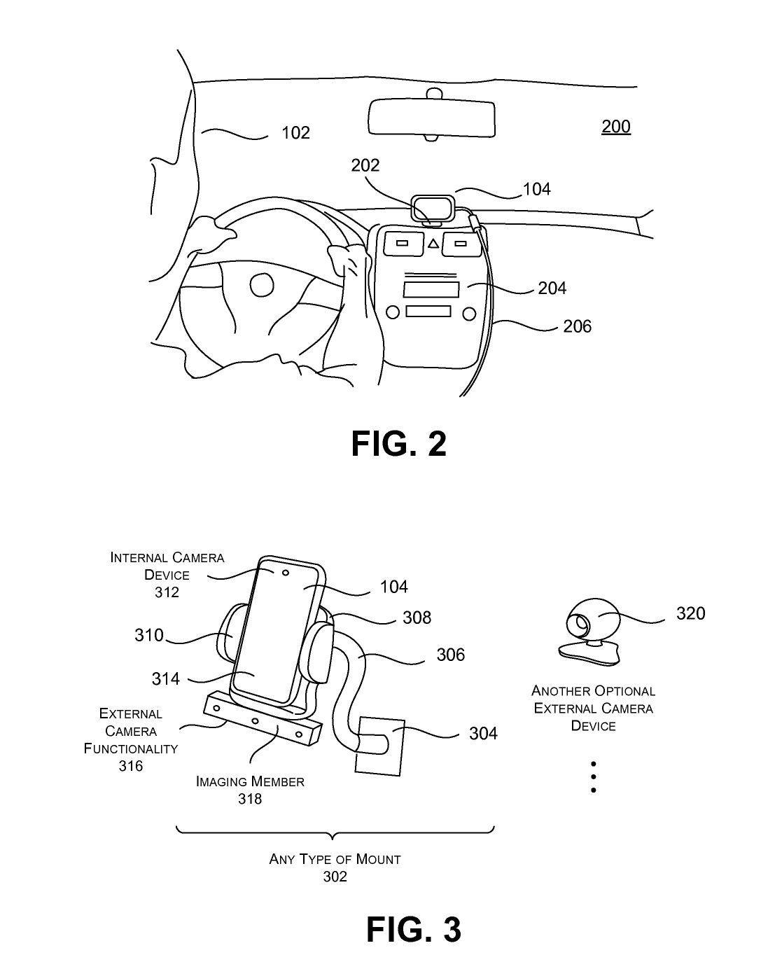

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative mobile device that has functionality for detecting gestures made by a user within a vehicle, in association with a mount that secures the mobile device within the vehicle. Section B describes illustrative methods which explain the operation of the mobile device and mount of Section A. Section C describes illustrative computing functionality that can be used to implement any aspect of the features described in Sections A and B.

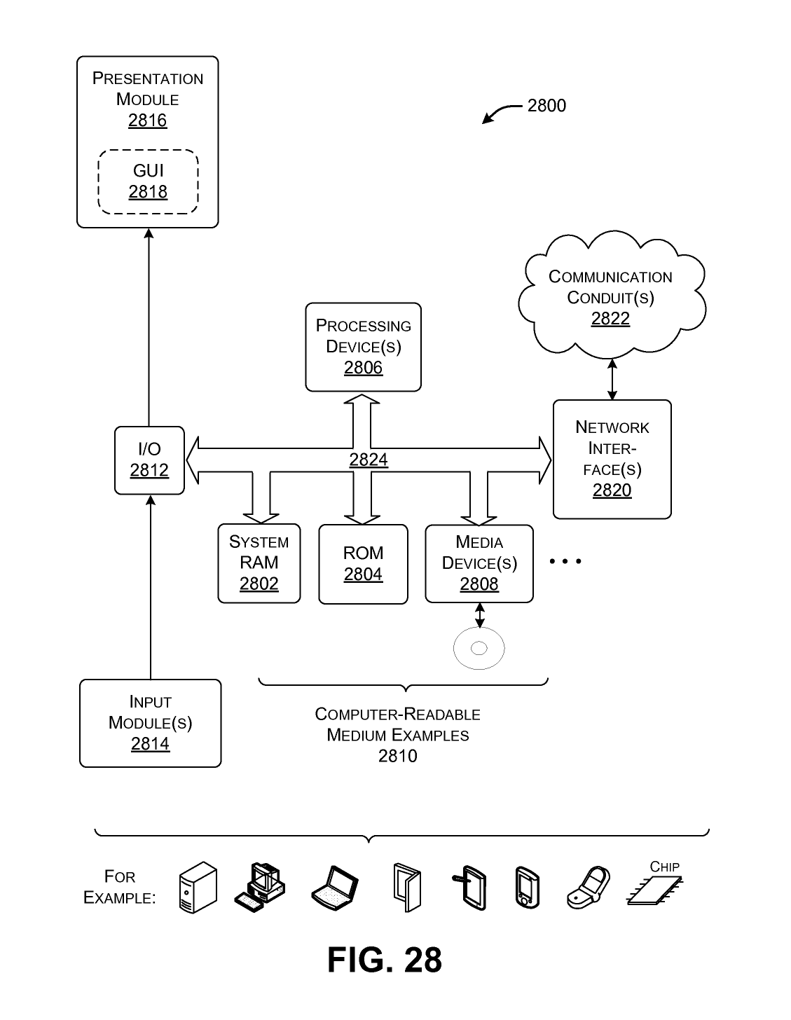

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 28, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof.

As to terminology, the phrase “configured to” encompasses any way that any kind of physical and tangible functionality can be constructed to perform an identified operation. The functionality can be configured to perform an operation using, for instance, software, hardware (e.g., chip-implemented logic functionality), firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware (e.g., chip-implemented logic functionality), firmware, etc., and/or any combination thereof. When implemented by a computing system, a logic component represents an electrical component that is a physical part of the computing system, however implemented.

The phrase “means for” in the claims, if used, is intended to invoke the provisions of 35 U.S.C. §112, sixth paragraph. No other language, other than this specific phrase, is intended to invoke the provisions of that portion of the statute.

The following explanation may identify one or more features as “optional.”This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations

A. Illustrative Mobile Device and its Environment of Use

FIG. 1 shows an illustrative environment 100 in which users can operate mobile devices within vehicles. For example, FIG. 1 depicts an illustrative user 102 who operates a mobile device 104 within a vehicle 106, and a user 108 who operates a mobile device 110 within a vehicle 112. However, the environment 100 can accommodate any number of users, mobile devices, and vehicles. To simplify the explanation, this section will set forth the illustrative composition and manner of operation of the mobile device 104 operated by the user 102, treating this mobile device 104 as representative of any mobile device's operation within the environment 100.

More specifically, the mobile device 104 operates in at least two modes. In a handheld mode of operation, the user 102 can interact with the mobile device 104 while holding it in his or her hands. For example, the user 102 can interact with a touch input screen of the mobile device 104 and/or a keypad of the mobile device 104 to perform any device function. In a gesture-recognition mode of operation, the user 102 can interact with the mobile device 104 by making gestures that are detected by the mobile device 104 based on image information captured by the mobile device 104. In this mode, the user 102 need not make physical contact with the mobile device 104. In one case, the user 102 can perform a gesture by making a static pose with at least one hand. In another case, the user 102 can make a dynamic gesture by moving at least one hand in a prescribed manner.

The user 102 may choose to interact with the mobile device 104 in the gesture-recognition mode in various circumstances, such as when the user 102 is operating the vehicle 106. The gesture-recognition mode is well suited for use in the vehicle 106 because this mode makes reduced demands on the attention of the user 102, compared to the handheld interaction mode of operation. For example, the user 102 need not divert his or her focus of attention from driving-related tasks while making gestures, at least not for any extended period of time. Further, the user 102 can maintain at least one hand on the steering wheel of the vehicle 106 while making gestures; indeed, in some cases, the user 102 can maintain both hands on the wheel. These considerations make the gesture-recognition mode potentially safer and easier to use while driving the vehicle 106, compared to the handheld mode of operation.

The mobile device 104 can be implemented in any manner and can perform any function or combination of functions. For example, the mobile device 104 can correspond to a mobile telephone device of any type (such as a smart phone device), a book reader device, a personal digital assistant device, a laptop computing device, a netbook-type computing device, a tablet-type computing device, a portable game device, a portable media system interface module device, and so on.

The vehicle 106 can correspond to any mechanism for transporting the user 102. For example, the vehicle 106 may correspond to an automobile of any type, a truck, a bus, a motorcycle, a scooter, a bicycle, an airplane, a boat, and so on. However, to facilitate explanation, it will henceforth be assumed that the vehicle 106 corresponds to a personal automobile operated by the user 102.

The environment 100 also includes a communication conduit 114 for allowing the mobile device 104 to interact with any remote entity (where a “remote entity” means an entity that is remote with respect to the user 102). For example, the communication conduit 114 may allow the user 102 to use the mobile device 104 to interact with another user who is using another mobile device (such as user 108 who is using the mobile device 110). In addition, the communication conduit 114 may allow the user 102 to interact with any remote services. Generally speaking, the communication conduit 114 can represent a local area network, a wide area network (e.g., the Internet), or any combination thereof. The communication conduit 114 can be governed by any protocol or combination of protocols.

More specifically, the communication conduit 114 can include wireless communication infrastructure 116 as part thereof. The wireless communication infrastructure 116 represents the functionality that enables the mobile device 104 to communicate with remote entities via wireless communication. The wireless communication infrastructure 116 can encompass any of cell towers, base stations, central switching stations, satellite functionality, and so on. The communication conduit 114 can also include hardwired links, routers, gateway functionality, name servers, etc.

The environment 100 also includes one or more remote processing systems 118. The remote processing systems 118 provide any type of services to the users. In one case, each of the remote processing systems 118 can be implemented using one or more servers and associated data stores. For instance, FIG. 1 shows that the remote processing systems 118 can include at least one instance of remote processing functionality 120 and an associated system store 122. The ensuing description will set forth illustrative functions that the remote processing functionality 120 can perform that are germane to the operation of the mobile device 104 within the vehicle 106.

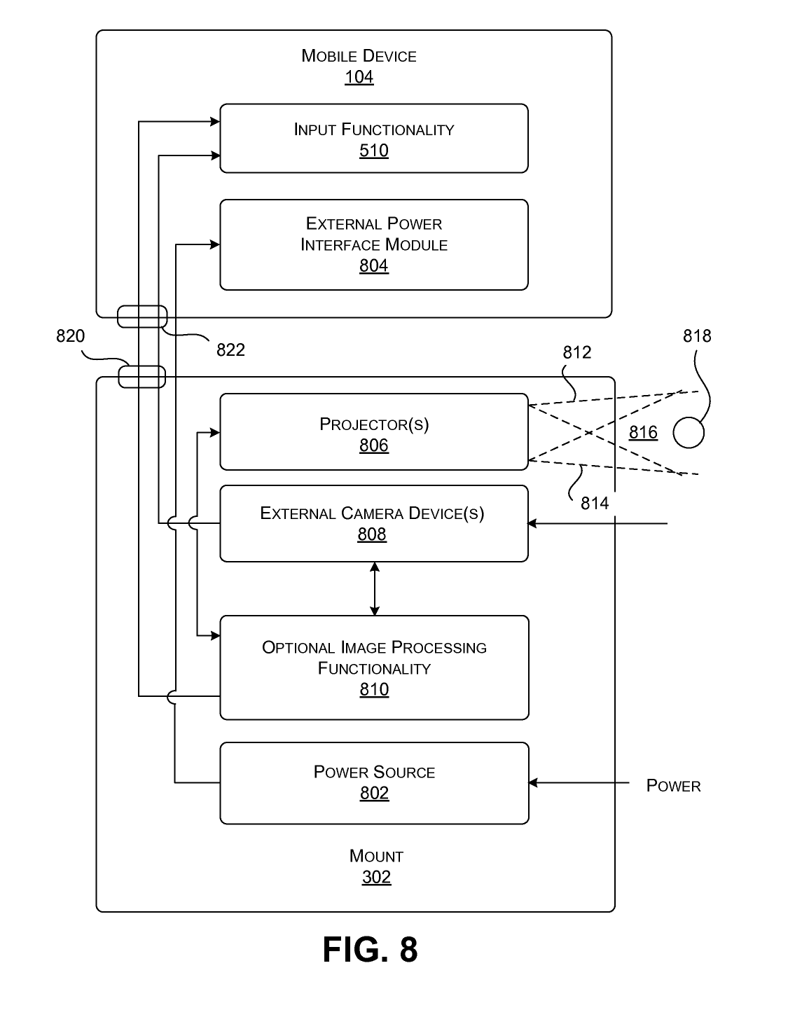

Advancing to FIG. 2, this figure shows a portion of a representative interior region 200 of the vehicle 106. A mount 202 secures the mobile device 104 within the interior region 200. In this particular example, the user 102 has positioned the mobile device 102 in proximity to a control panel region 204. More specifically, the mount 202 secures the mobile device 104 to the top of the vehicle's dashboard, to the left of the user 102, just above the vehicle control panel region 202. A power cord 206 supplies power from any power source provided by the vehicle 106 to the mobile device 104 (either directly or indirectly, as will be described in connection with FIG. 8, below).

However, the placement of the mobile device 104 shown in FIG. 2 is merely representative, meaning that the user 102 can choose other locations and orientations of the mobile device 104. For example, the user 102 can place the mobile device 104 in a left region with respect to the steering wheel, instead of a right region of the steering wheel (as shown in FIG. 2). This might be appropriate, for example, in countries in which the steering wheel is provided on the right side of the vehicle 106. Alternatively, the user 102 can place the mobile device 104 directly behind the steering wheel or on the steering wheel. Alternatively, the user 102 can secure the mobile device 104 to the windshield of the vehicle 106. These options are mentioned by way of illustration, not limitation; still other placements of the mobile device 104 are possible.

FIG. 3 shows one merely representative mount 302 that can be used to secure the mobile device 104 to some surface of the interior region 200 of the car. (Note that this mount 302 is a different type of mount than the mount 202 shown in FIG. 2). Without limitation, the mount 302 of FIG. 3 includes any type of mechanism 304 for fastening the mount 302 to a surface within the interior region 200. For instance, the mechanism 304 can include a clamp or protruding member (not shown) that attaches to an air movement grill of the vehicle. In other cases, the mechanism 304 can include a plate or other type of member which can be fastened to any surface of the interior region 200, including the dashboard, the windshield, the front face of the control panel region 202, and so on; in this implementation, the mechanism 304 can include the use any type of fastener to attach the mount 302 to the surface (e.g., screws, clamps, a Velcro coupling mechanism, a sliding coupling mechanism, a snapping coupling mechanism, a suction cup coupling mechanism, etc.). In still other cases, the mount 302 can merely sit on a generally horizontal surface of the interior region 200, such as on the top of the dashboard, without being fastened to that surface. To reduce the risk of this type of mount sliding on the surface during movement of the vehicle 106, it can include a weighted member, such as a sand-filled malleable base member.

Without limitation, the representative mount 302 shown in FIG. 3 includes a flexible arm 306 which extends from the mechanism 304 and terminates in a cradle 308. The cradle 308 can include an adjustable clamp mechanism 310 for securing the mobile device 104 to the cradle 308. In this particular scenario, the user 102 has attached the mobile device 104 to the cradle 308 so that it can be operated in a portrait mode. But the user 102 can alternatively attach the mobile device 104 so that it can be operated in a landscape mode (as shown in FIG. 2).

The mobile device 104 includes at least one internal camera device 312 of any type. As used herein, a camera device includes any mechanism for receiving image information. At least one of these internal camera devices has a field of view that projects out from a front face 314 of the mobile device 104. The internal camera device 312 is identified as “internal” insofar as it typically considered an integral part of the mobile device 104. In some cases, the internal camera device 312 can also correspond to a detachable component of the mobile device 104.

In addition, the mobile device 104 can receive image information from one or more external camera devices. These camera devices are external in the sense that they are not considered as integral parts of the mobile device 104. For instance, the mount 302 itself can incorporate external camera functionality 316. The external camera functionality 316 will be described in greater detail at a later juncture of the explanation. By way of overview, the external camera functionality 316 can include one or more external camera devices of any type. In addition, or alternatively, the external camera functionality 316 can include one or more projectors for illuminating a scene. In addition, or alternatively, the external camera functionality 316 can include any type of image processing functionality for processing image content received from the external camera device(s).

In one implementation, an imaging member 318 can house the external camera functionality 316. The imaging member 318 can have any shape and any placement with respect to the other parts of the mount 302. In the merely illustrative case of FIG. 3, the imaging member 318 corresponds to an elongate bar that extends in a generally horizontal orientation, beneath the cradle 310. In this merely illustrative case, the imaging member 318 includes a linear array of apertures through which the camera device(s) receive image content, and through which the projector(s) send out electromagnetic radiation. For example, in one case, the two apertures on the distal ends of the imaging member 318 may be associated with two respective projectors, while the middle aperture may be associated with an external camera device.

The interior region 200 can also include one or more additional external camera devices that are separate from both the mobile device 104 and the mount 302. FIG. 3 shows one such illustrative external camera device 320. The user 102 can place the separate external camera device 320 at any location and orientation within the interior region 200, on any surface of the vehicle 106. Generally, a user may opt to use two or more camera devices to enhance the ability of the mobile device to detect gestures (as will be described below).

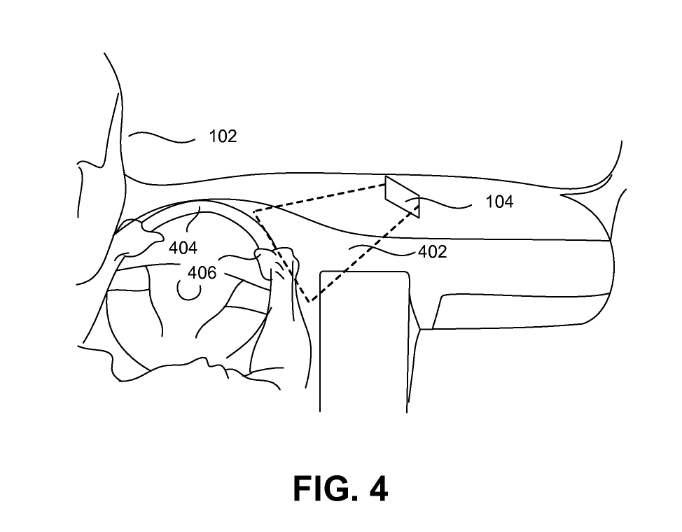

FIG. 4 shows the use of the mobile device 104 to establish an interaction space 402 within the interior space 200 of the vehicle 106. The interior space 402 defines a volume of space in which the mobile device 104 (and/or the processing functionality of the mount 302) can most readily detect gestures made by the user 102. That is, in one implementation, the mobile device 104 will not detect gestures made by the user 102 outside the interaction space 402.

In one implementation, the interaction space 402 corresponds to a generally conic volume having prescribed dimensions. That volume extends out from the mobile device 104, pointed towards the user 102 who is seated in the driver's seat of the vehicle 106. In one implementation, the interaction space 402 extends about 60 cm from the mobile device 104. The distal end of that volume encompasses the edges of the steering wheel 404 of the vehicle 106. Accordingly, the user 102 can make gestures by extending his or her right hand 406 into the interaction space, and then making the telltale gesture at that location. Alternatively, the user 102 can make a telltale gesture while keeping both hands on the steering wheel 404.

In some implementations, the mobile device 104 can include a gesture calibration module (to be described). As one function, the gesture calibration module can guide the user 102 in positioning the mobile device 104 to set up the interaction space 402. Further, the gesture calibration module can include a setting which allows the user 102 to adjust the shape of the interaction volume 402, or at least the outward reach of the interaction volume 402. For example, the user 102 can use the gesture calibration module to increase the reach of the interaction space 402 to encompass hand gestures that a user 102 makes by touching his or her hand to his or her face. FIG. 8 will provide additional details regarding different ways in which the mobile device 104 (and the mount 302) can establish the interaction space 402.

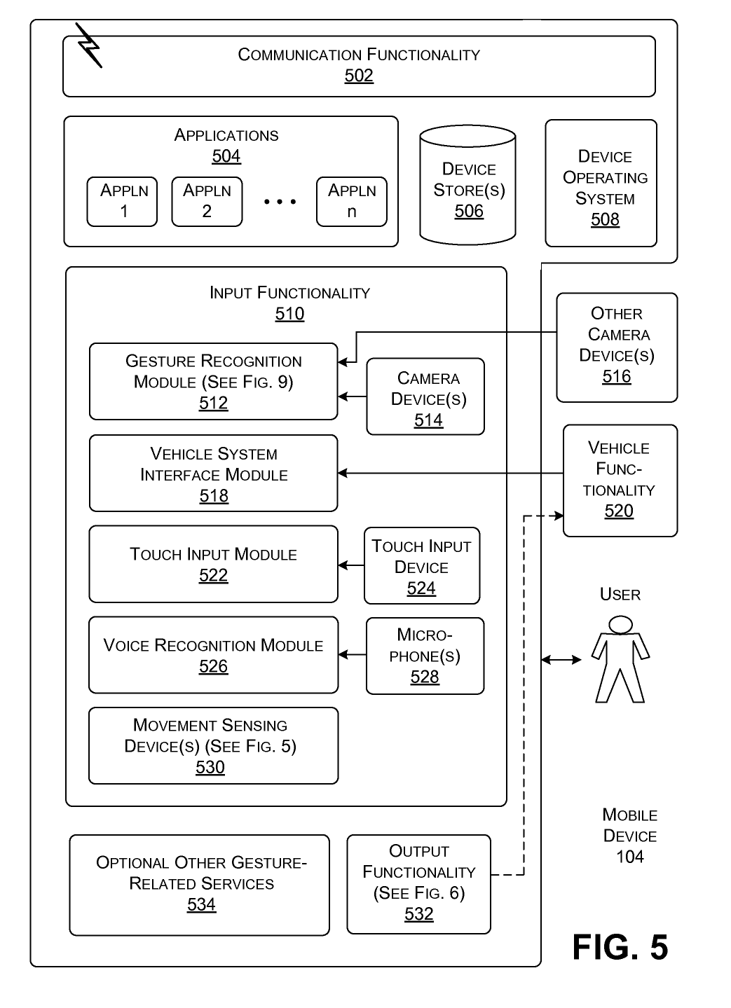

FIG. 5 shows various components that can be used to implement the mobile device 104. This figure will be described in a generally top-to-bottom manner. To begin with, the mobile device 104 includes communication functionality 502 for receiving and transmitting information to remote entities via wireless communication. That is, the communication functionality 502 may comprise a transceiver that allows the mobile device 104 to interact with the wireless communication infrastructure 116 of the communication conduit 114.

The mobile device 104 can also include a set of one or more applications 504. The applications 504 represent any type of functionality for performing any respective tasks. In some cases, the applications 504 perform high-level tasks. To cite representative examples, a first application may perform a map navigation task, a second application can perform a media presentation task, a third application can perform an Email interaction task, and so on. In other cases, the applications 504 perform lower-level management or support tasks. The applications 504 can be implemented in any manner, such as by executable code, script content, etc., or any combination thereof The mobile device 104 can also include at least one device store 506 for storing any application-related information, as well as other information. In other implementations, at least part of the operations performed by the applications 504 can be implemented by the remote processing systems 118. For example, in certain implementations, some of the applications 504 may represent network-accessible pages.

The mobile device 104 can also include a device operating system 508. The device operating system 508 provides functionality for performing low-level device management tasks. Any application can rely on the device operating system 508 to utilize various resources provided by the mobile device 104.

The mobile device 104 can also include input functionality 510 for receiving and processing input information. Generally, the input functionality 510 includes some modules for receiving input information from internal input devices (which represent fixed and/or detachable components that are part of the mobile device 104 itself), and some modules for receiving input information from external input devices. The input functionality 510 can receive input information from external input devices using any coupling technique or combination of coupling techniques, such as hardwired connections, wireless connections (e.g., Bluetooth® connections), and so on.

The input functionality 510 includes a gesture recognition module 512 for receiving image information from at least one internal camera device 514 and/or from at least one external camera device 516 (e.g., from one or more camera devices associated with the mount 302, and/or one or more other external camera devices). Any of these camera devices can provide any type of image information. For example, in one case, a camera device can provide image information by receiving visible spectrum radiation, or infrared spectrum radiation, etc. For example, in one case, a camera device can receive infrared spectrum radiation by including a bandpass filter which blocks or otherwise diminishes the receipt of visible spectrum radiation. In addition, the gesture recognition module 512 (and/or some other component of the mobile device 104 and/or the mount 302) can optionally produce depth information based on the image information. The depth information reveals distances between different points in a captured scene and a reference point (e.g., corresponding to the location of the camera device). The gesture recognition module 512 can generate the depth information using any technique, such as a time-of-flight technique, a structured light technique, a stereoscopic technique, and so on (as will be described in greater detail below).

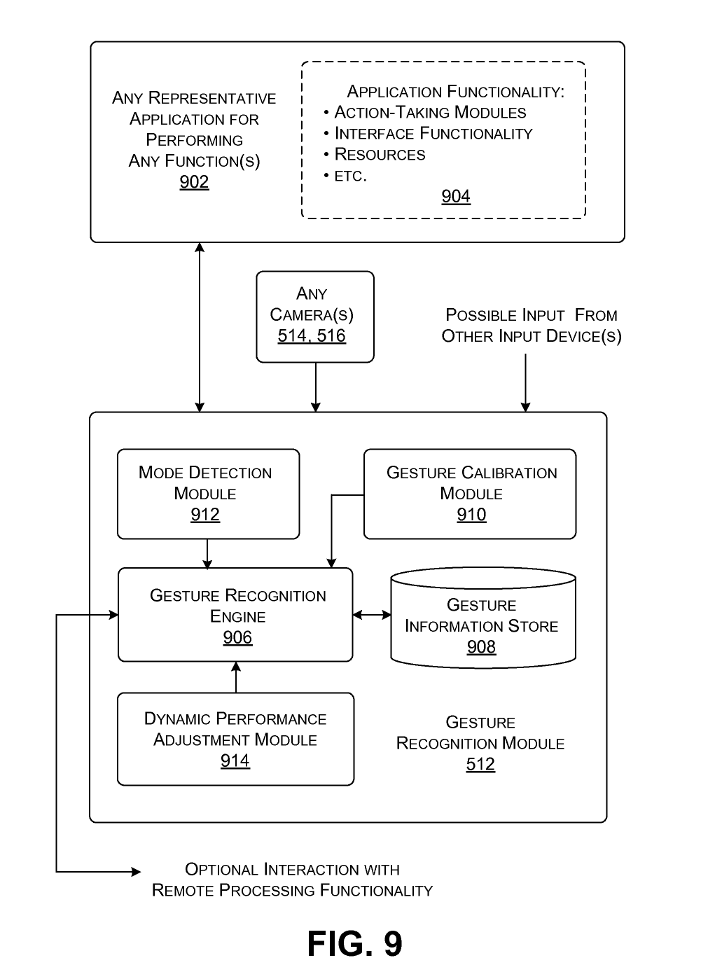

After receiving the image information, the gesture recognition module 512 can determine whether the image information reveals that the user 102 has made a recognizable gesture, e.g., based on the original image information alone, the depth information, or both the original image information and the depth information. Additional details regarding the illustrative composition and operation of the gesture recognition module 512 are provided below in the context of the description of FIG. 9.

The input functionality 510 can also include a vehicle system interface module 518. The vehicle system interface module 518 receives input information from any vehicle functionality 520. For example, the vehicle system interface module 518 can receive any type of OBDII information provided by the vehicle's information management system. Such information can describe the operating state of the vehicle at a particular point in time, such as by providing the vehicle's speed, steering state, breaking state, engine temperature, engine performance, odometer reading, oil level, and so on.

The input functionality 510 can also include a touch input module 522 for receiving input information when a user touches a touch input device 524. Although not depicted in FIG. 5, the input functionality 510 can also include any type of physical keypad input mechanism, any type of joystick control mechanism, any type of mouse device mechanism, and so on. The input functionality 510 can also include a voice recognition module 526 for receiving voice commands from one or more microphones 528.

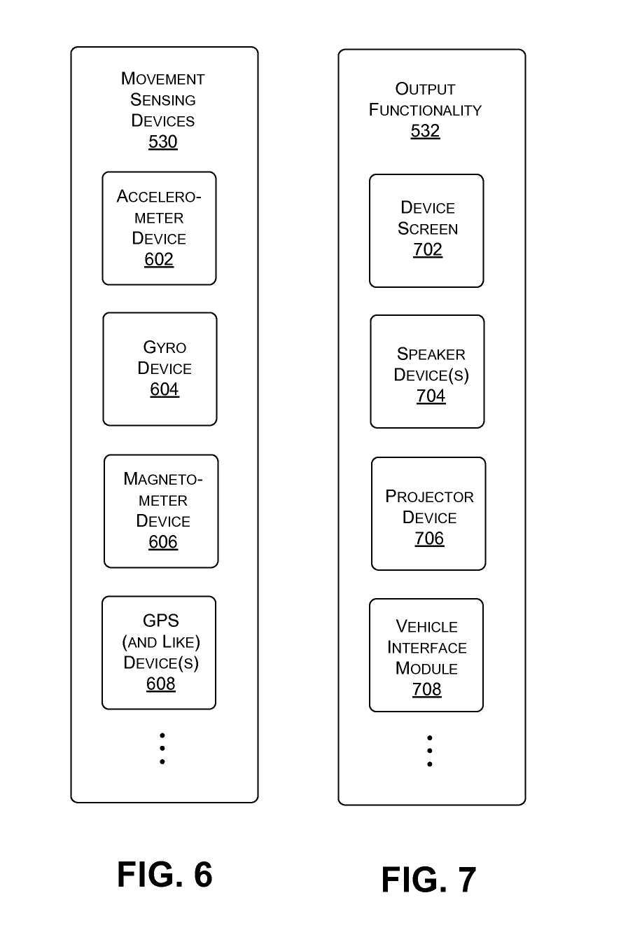

The input functionality 510 can also include one or more movement sensing devices 530. Generally, the movement sensing devices 130 determine the manner in which the mobile device 104 is being moved at any given time, and/or the absolute and/or relative position of the mobile device 104 at any given time. Advancing momentarily to FIG. 6, this figure indicates that the movement sensing devices 530 can include any of an accelerometer device 602, a gyro device 604, a magnetometer device 606, a GPS device 608 (or other satellite-based position-determining mechanism), a dead-reckoning position-determining device (not shown), and so on. This set of possible devices is representative, rather than exhaustive.

The mobile device 104 also includes output functionality 532 for conveying information to a user. Advancing momentarily to FIG. 7, this figure indicates that the output functionality 532 can include any of a device screen 702, one or more speaker devices 704, a projector device 706 for projecting output information onto a surface, and so on. The output functionality 532 also includes a vehicle interface module 708 that enables the mobile device 104 to send output information to any external system associated with the vehicle 106. This ultimately means that the user 102 can use gestures to control the operation of any functionality associated with the vehicle 106 itself, via the mediating role of the mobile device 104. For example, the user 102 can control the playback of media content on a separate vehicle media system using the mobile device 104. The user 102 may prefer to directly interact with the mobile device 104 rather than the systems of the vehicle 106 because the user 102 is presumably already familiar with the manner in which the mobile device 104 operates. Moreover, the mobile device 104 has access to a remote system store 122 which can provide user-specific information. The mobile device 104 can leverage this information to provide user-customized control of any system provided by the vehicle 106.

Finally, the mobile device 104 can optionally provide any other gesture-related services 534. For example, some gesture-related services can provide particular gesture-based user interface routines that any application can integrate into its functionality, e.g., by making appropriate calls to these services during execution of the application.

FIG. 8 illustrates one manner in which the functionality provided by the mount 302 (of FIG. 3) can interact with the mobile device 104. The mount 302 can include a power source 802 which feeds power to the mobile device 104, e.g., via an external power interface module 804 provided by the mobile device 104. The power source 802 may, in turn, receive power from any external source, such as a power source (not shown) associated with the vehicle 106. In this implementation, the power source 802 powers both the components of the mount 302 and the mobile device 104. Alternatively, each of the mobile device 104 and the mount 302 can be powered by separate respective power sources.

The mount 302 can optionally include various components that implement the external camera functionality 316 of FIG. 4. Such components can include one or more optional projectors 806, one or more optional external camera devices 808, and/or image processing functionality 810. These components can work in conjunction with the functionality provided by the mobile device 104 to supply and process image information. The image information captures a scene that encompasses the interaction space 402 shown in FIG. 4.

By way of preliminary clarification, the following explanation will identify certain components involved in the production of image information as being implemented by the mount 302 and certain components as being implemented by the mobile device 104. But any functions that are described as being performed by the mount 302 can instead (or in addition) be performed by the mobile device 104, and vice versa. For that matter, one or more components of the gesture recognition module 512 itself can be implemented by the mount 302.

The mobile device 104, in conjunction with the mount 302, can use one or more techniques to detect objects placed in the interaction space 402. Representative techniques are described as follows.

(A) In a first case, the mobile device 104 can use one or more of the projectors 806 to project structured light towards the user 102 into the interaction space 402. The structured light may comprise any light that exhibits a pattern of any type, such as an array of dots. The structured light “deforms” when it spreads over an object having a three dimensional shape (such as the user's hand). One or more camera devices (either on the mount 302 and/or on the mobile device 104) can then receive image information that captures the object(s) that have been illuminated with the structured light. The image processing functionality 810 (and/or the gesture recognition module 512) can process the received image information to derive depth information. The depth information reveals the distances between different points on the surface of the object(s) and a reference point. The image processing functionality 810 (and/or the gesture recognition module 512) can then use the depth information to extract any gestures that are made within the volume of space associated with the interaction space 402.

(B) In another technique, two or more camera devices (provided by the mount 302 and/or the mobile device 104) can capture plural instances of image information from two or more respective viewpoints. The image processing functionality 810 (and/or the gesture recognition module 512) can then use a stereoscopic technique to extract depth information regarding the captured scene from the various instances of image information. The image processing functionality 810 (and/or the gesture recognition module 512) can then use the depth information to extract any gestures that are made within the volume of space associated with the interaction space 402.

(C) In yet another technique, one or more projectors 806 in conjunction with one or more camera devices (provided by the mount 302 and/or the mobile device 104) can use a time-of-flight technique to extract depth information from a scene. The image processing functionality 810 (and/or the gesture recognition module 512) can again reconstruct depth information from the scene and use that depth information to extract any gestures that are made within the interaction space 402.

(D) In yet another technique, one or more projectors 806 can project electromagnetic radiation of any spectrum into a region of space from one or more different viewpoints. For example, FIG. 8 shows that a first projector projects radiation out define a first beam 812 of light, and a second projector projects radiation out to form a second beam 814 of light. The two beams (812, 814) intersect in a region 816 that defines the intersection space 402. An object 818 (such as the user's hand) will receive a greater amount of illumination when it is placed in the region 816, compared to when it lies outside the region 816. One or more camera devices (provided by the mount 302 and/or the mobile device 104) can capture image information from a scene, including the region 816. The image processing functionality 810 (and/or the gesture recognition module 512) can then be tuned to pick out those objects that are particularly bright within the image information, which has the effect of detecting objects placed in the region 816 which are brightly lit. In this manner, the image processing functionality 810 (and/or the gesture recognition module 512) can extract gestures made within the interaction space 402 without formally deriving depth information.

Still other techniques can be used to identify gestures made within the interaction space 402. In general, the gesture recognition module 512 can recognize gestures using original (“raw”) image information captured by one or more camera devices, depth information derived from the original image information (or any other information derived from the original image information), or both the original image information and the depth information, etc.

The projectors 806 and the various internal and/or external camera devices can project and receive radiation in any portion of the electromagnetic spectrum. In some cases, for instance, at least some of the projectors 806 can project infrared radiation and at least some of the camera devices can receive infrared radiation. For example, in one technique, the camera devices can receive infrared radiation by using a bandpass filter which has the effect of blocking or at least diminishing radiation outside the infrared portion of the spectrum (including visible light). The use of infrared radiation has various potential merits. For example, the mobile device 104 and/or the external camera functionality 316 of the mount 302 can use infrared radiation to help discriminate gestures made within a darkened vehicle interior. In addition, or alternatively, the mobile device 104 and/or the external camera functionality 316 can use infrared radiation to effectively ignore noise associated with ambient visible light within the interior region of the vehicle 106.

Finally, FIG. 8 shows interfaces (820, 822) that allow the input functionality 510 of the mobile device 104 to communicate with the components of the mount 302.

FIG. 9 shows additional information regarding a subset of the components of the mobile device 104, introduced above in the context of FIGS. 5-8. The components include a representative application 902 and the gesture recognition module 512. As the name suggests, the “representative application” 902 represents one of the set of applications 504 that may run on the mobile device 104.

More specifically, FIG. 9 depicts the representative application 902 and the gesture recognition module 512 as separate entities that perform respective functions. Indeed, in one implementation, the mobile device 104 can devote distinct components for performing the tasks associated with the representative application 902 and the gesture recognition module 512. But in other cases, the mobile device 104 can combine modules together in any way, such that any single component shown in FIG. 9 may represent an integral component within a larger body of functionality.

To illustrate the above point, consider two different development environments in which a developer may create the representative application 902 for execution on the mobile device 104. In a first case, the mobile device 104 implements an application-independent gesture recognition module 512 for use by any application. In this case, the developer can design the representative application 902 in such a manner that it leverages the services provided by the gesture recognition module 512. The developer can consult an appropriate software development kit (SDK) to assist him or her in performing this task. The SDK describes the input and output interfaces of the gesture recognition module 512, and other characteristics and constraints of its manner of operation.

In a second case, the representative application 902 can implement at least parts of the gesture recognition module 512 as part thereof. This means that at least parts of the gesture recognition module 512 can be considered as integral components of the representative application 902. The representative application 902 can also modify the manner of operation of the gesture recognition module 512 in any respect. The representative application 902 can also supplement the manner of operation of the gesture recognition module 512 in any respect.

Moreover, in other implementations, one or more aspects of the gesture recognition module 512 can be performed by the processing functionality 810 associated with the mount 302.

In any implementation, the representative application 902 can be conceptualized as comprising application functionality 904. The application functionality 904, in turn, can be conceptualized as providing a plurality of action-taking modules that performs respective functions. In some cases, an application-taking module can receive input from the user 102 in the gesture-recognition mode. In response to that input, the action-taking module can perform some control action that affects the operation of the mobile device 104 and/or some external vehicle system. Examples of such control actions will be presented in the context of the examples presented below. To cite merely one example, an action-taking module can perform a media “rewind” function in response to receiving a telltale “backward” gesture from the user 102 that invokes this operation.

The application functionality 904 can also include a set of application resources. The application resources represent image content, text content, audio content, etc. that the representative application 902 may use to provide its services. Moreover, in some cases, a developer can provide multiple collections of application resources for invocation in different respective modes. For example, an application developer can provide a collection of user interface icons and prompting messages that the mobile device 104 can present when the gesture-recognition mode has been activated. An application developer can provide another collection of icons and prompting messages for use in the handheld mode of operation. The SDK may specify certain constraints that apply to each mode. For example, the SDK may request that prompting messages for use in the gesture-recognition mode have at least a minimum font size and/or spacing and/or character length to facilitate the user's speedy comprehension of the messages while driving the vehicle 106.

The application functionality 904 can also include interface functionality. The interface functionality defines the interface-related behavior of the mobile device 104. In some cases, for instance, the interface functionality may define interface routines that govern the manner in which the application functionality 904 solicits gestures from the user 102, confirms the recognition of gestures, addresses input errors, and so forth.

The types of application functionality 904 enumerated above are not necessarily mutually exclusive. For example, part of an action-taking module may incorporate aspects of the interface functionality. Further, FIG. 9 identifies the application functionality 904 as being a component of the representative application 902. But any aspect of the representative application 902 can alternatively (or in addition) be implemented by the gesture recognition module 512.

Advancing now to a description of the gesture recognition module 512, this functionality includes a gesture recognition engine 906 for recognizing gestures using any image analysis technique. Stated in general terms, the gesture recognition engine 906 operates by extracting features which characterize image information that captures a static or dynamic gesture made by a user. Those features define a feature signature. The gesture recognition engine 906 can then classify the gesture that has been performed based on the feature signature. In the following description, the general term “image information” will encompass original image information received from one or more camera devices, depth information (and/or other information) derived from the original image information, or both original image information and depth information.

For example, in one merely representative case, the gesture recognition engine 906 may begin by receiving image information from one or more camera devices (514, 516). The gesture recognition engine 906 can then subtract background information from the input image information, leaving foreground information. The gesture recognition engine 906 can then parse the foreground image information to generate body representation information. The body representation information represents one or more body parts of the user 102. For example, in one implementation, the gesture recognition engine 906 can express the body representation information as a skeletonized representation of the body parts, e.g., comprising one of more joints and one or more segments connecting the joints together. In one scenario, the gesture recognition engine 906 can form body representation information that includes just the forearm and hand of the user 102 that is nearest to the mobile device 104 (e.g., the user's right forearm and hand). In another scenario, the gesture recognition engine 906 can form body representation information that includes the entire upper torso and head region of the user 102.

As a next step, the gesture recognition engine 906 can compare the body representation information with plural instances of candidate gesture information provided in a gesture information store 908. Each instance of the candidate gesture information characterizes a candidate gesture that can be recognized. As a result of this comparison, the gesture recognition engine 906 can form a confidence score for each candidate gesture. The confidence score conveys a closeness of a match between the body representation information and the candidate gesture information for a particular candidate gesture. The gesture recognition engine 906 can then select the candidate gesture that provides the highest confidence score. If this highest confidence score exceeds a prescribed environment-specific threshold, then the gesture recognition engine 906 concludes that the user 102 has indeed performed the gesture associated with the highest confidence score. In certain cases, the gesture recognition engine 906 may not be able to identify any candidate gesture having a suitably high confidence score; in this circumstance, the gesture recognition engine 906 may refrain from indicating that a match has occurred. Optionally, the mobile device 104 can use this occasion to invite the user 102 to repeat the gesture in question, or provide supplemental information regarding the nature of the command that the user 102 is attempting to invoke.

The gesture recognition engine 906 can perform the above-described matching in different ways. In one case, the gesture recognition engine 906 can use a statistical model to compare the body representation information with the candidate gesture information associated with each of a plurality of candidate gestures. The statistical model is defined by parameter information. That parameter information, in turn, can be derived in a machine-learning training process. A training module (not shown) performs the training process based on image information that depicts gestures made by a population of users, together with labels that identify the actual gestures that the users were attempting to perform.

To repeat, the above-described gesture-recognition technique is described by way of example, not limitation. In other cases, the gesture recognition engine 906 can perform matching by directly comparing input image information with telltale candidate gesture image information, that is, without first forming skeletonized body representation information.

In another implementation, the system and techniques described in co-pending and commonly-assigned U.S. Ser. No. 12/603,437 (the '437 Application), filed on Oct. 21, 2009, can also be used to implement at least parts of the gesture recognition engine 906. The '437 Application is entitled “Pose Tracking Pipeline,” and names the inventors of Robert M. Craig, et al.

The above-described procedures can be used to recognize any types of gestures. For example, the gesture recognition engine 906 can be configured to recognize static gestures made by the user 102 with one or more body parts. For example, a user 102 can perform one such static gesture by making a static “thumbs-up” pose with his or her right hand, within the interaction space 402. An application may interpret this action as an indication that a user 102 has communicated his or her approval with respect to some issue or option. In the case of static gestures, the gesture recognition engine 906 can form static body representation information and compare that information with static candidate gesture information.

In addition, or alternatively, the gesture recognition engine 906 can be configured to recognize dynamic gestures made by the user 102 with one or more body parts, e.g., by moving the body parts along a telltale path within the interaction space 402. For example, a user 102 can make one such dynamic gesture by moving his or her index finger within a circle within the interaction space 402. An application may interpret this gesture as a request to repeat some action. In the case of dynamic gestures, the gesture recognition engine 906 can form temporally-varying body representation information and compare that information with temporally-varying candidate gesture information.

In the above example, the mobile device 104 associates gestures with respective actions. More specifically, in some design environments, the gesture recognition engine 906 can define a set of universal gestures that have the same meaning across different applications. For example, all applications can universally interpret a “thumbs up” gesture as an indication of the user's approval. In other design environments, an individual application can interpret any gesture in any idiosyncratic (application-specific) manner. For example, an application can interpret a “thumbs up” gesture as a request to navigate in an upward direction.

In some implementations, the gesture recognition engine 906 operates based on image information received from a single camera device. As said, that image information can capture a scene using visible spectrum light (e.g., RGB information), or using infrared spectrum radiation, or using some other kind of electromagnetic radiation. In some cases, the gesture recognition engine 906 (and/or the processing functionality 810 of the mount 302) can further process the image information to provide depth information using any of the techniques described above.

In other implementations, the gesture recognition engine 906 can receive and process image information obtained from two or more camera devices of the same type or different respective types. The gesture recognition engine 906 can process two instances of image information in different ways. In one case, the gesture recognition engine 906 can perform independent analysis on each instance of image information (provided by a particular image source) to derive a source-specific conclusion as to what gesture the user 102 has made, together with a source-specific confidence score associated with that judgment. The gesture recognition engine 906 can then form a final conclusion based on the individual source-specific conclusions and associated source-specific confidence scores.

For example, assume that the gesture recognition engine 906 concludes that the user 102 has made a stop gesture based on a first instance of image information received from a first device camera, with a confidence score of 0.60; further assume that the gesture recognition engine 906 concludes that the user 102 has made a stop gesture based on a second instance of image information received from a second device camera, with a confidence score of 0.55. The gesture recognition engine 906 can generate a final conclusion that the user 102 has indeed made a stop gesture, with a final confidence score that is based on some kind of joint consideration of the two individual confidence scores. Generally, in this case, the individual confidence scores will combine to produce a final score that is larger than either of the two original individual confidence scores. If the final confidence score exceeds a prescribed threshold, the gesture recognition engine 906 can assume that the gesture has been satisfactorily recognized and can accordingly output that conclusion. In other scenarios, the gesture recognition engine 906 can conclude, based on image information received from a first camera device, that a first gesture has been made; the gesture recognition engine 906 can also conclude, based on image information received from a second camera device, that a second gesture has been made, where the first gesture differs from the second gesture. In this circumstance, the gesture recognition engine 906 can potentially discount the confidence of each conclusion due to the disagreement among the separate analyses.

In another case, the gesture recognition engine 906 can combine separate instance of image information (received from separate camera devices) together to form a single instance of input image information. For example, the gesture recognition engine 906 can use a first instance of image information to supply missing image information (e.g., “holes”) in a second instance of the image information. Alternatively, or in addition, the different instances of image information may capture different “dimensions” of the user's gesture, e.g., using RGB video information received from a first camera device and depth information derived from image information provided by a second camera device. The gesture recognition engine 906 can combine these separate instances together to provide a more dimensionally robust instance of input image information for analysis. Alternatively, or in addition, the gesture recognition engine 906 can use a stereoscopic technique to combine two or more instances of image information together to form 3D image information.

FIG. 9 also indicates that the gesture recognition engine 906 can receive input information from input devices other than camera devices. For example, the gesture recognition engine 906 can receive raw voice information from one or more microphones 528, or already-processed voice information from the voice recognition module 526. The gesture recognition engine 906 can process this other input information in conjunction with the image information in different ways. In one case, as in the preceding description, the gesture recognition engine 906 can independently analyze the different instances of the input information to derive individual conclusions as to what gesture the user 102 had made, with associated confidence scores. The gesture recognition engine 906 can then derive a final conclusion and a final confidence score based on the individual conclusions and confidence scores.

For example, assume that the user 102 makes a stop gesture with his or her right hand while saying the word “stop.” Or the user 102 can make the gesture shortly after saying “stop,” or say the word “stop” shortly after making the gesture. The gesture recognition engine 906 can independently determine the gesture that the user 102 has made based on an analysis of the image information, while the voice recognition module 526 can independently determine the command that the user 102 has annunciated based on analysis of the voice information. Then, the gesture recognition engine 906 (or some other component of the mobile device 104) can generate a final interpretation of the gesture based on the outcome of the image analysis and voice analysis that has been performed. If the final confidence score of an identified gesture exceeds a prescribed threshold, the gesture recognition engine 906 can assume that the gesture has been successfully recognized.

A user may opt to interact with the mobile device 104 using the above-described hybrid mode of operation in circumstances in which there may be degradation of the image information and/or the voice information. For example, the user 102 may expect degradation of the image information in low lighting conditions (e.g., during operation of the vehicle 106 at night). The user 102 may expect degradation of the voice information in high noise conditions, as when the user 102 is traveling with the windows of the vehicle 106 open. The gesture recognition engine 906 can use the image information to overcome possible uncertainty in the voice information, and vice versa.

In the above description, the mobile device 104 represents the primary locus at which gesture recognition is performed. However, in other implementations, the environment 100 (of FIG. 1) can allocate any gesture-processing tasks set forth above to the remote processing functionality 120 and/or, as said, to the mount 302.

In addition, the environment 100 can leverage the remote processing functionality 120 and associated system store 122 to store a gesture-related profile for each user. That gesture-related profile may comprise model parameter information which characterizes the manner in which a particular user makes gestures. In general, the gesture-related profile for a first user may differ slightly from the gesture-related profile of a second user due to various factors (e.g., body shape, skin color, facial appearance, typical manner of dress, idiosyncrasies in forming static gesture poses, idiosyncrasies in forming dynamic gesture movements, and so on).

The gesture recognition module 512 can consult the gesture-related profile for a particular user when analyzing gestures made by that user. The gesture recognition engine 906 can access this profile either by downloading it and/or by making remote reference to it. The gesture recognition module 512 can also upload updated image information and associated gesture interpretations to the remote processing functionality 120. The remote processing functionality 120 can use this information to update the profiles for particular users. In the absence of user-specific profiles, the gesture recognition module 512 can use model parameter information that is developed for a general population of users, not any single user in particular. The gesture recognition module 512 can continuously update this generic parameter information in the manner described above, as actual users interact with their mobile devices in the gesture-recognition mode.

In another use case, a developer may define a set of new gestures to be used in conjunction with a particular application that the developer provides to users. The developer can express this new set of gestures using candidate gesture information and/or model parameter information. The developer can store that application-specific information in the remote system store 122 and/or in the stores of individual mobile devices. The gesture recognition engine 906 can consult the application-specific information when a user interacts with the application for which the new gestures were designed.

The gesture recognition module 512 can also include a gesture calibration module 910. The gesture calibration module 910 allows a user to calibrate the mobile device 104 for use in the gesture recognition mode. Calibration may encompass plural processes. In a first process, the gesture calibration module 910 can guide the user 102 in placing the mobile device 104 at an appropriate location and orientation within the interior region 200 of the vehicle 106. To perform this task, the gesture calibration module 910 can provide suitable instructions to the user 102. In addition, the gesture calibration module 910 can provide video feedback information to the user 102 which reveals the field of view captured by the internal camera device 514 of the mobile device 104. The user 102 can monitor this feedback information to determine whether the mobile device 104 is capable of “seeing” the gestures made by the user 102.

The gesture calibration module 910 can also provide feedback which describes the volumetric shape of the interaction space 402, e.g., by providing graphical markers overlaid on video feedback information. The gesture calibration module 910 can also include functionality that allows the user 102 to adjust any dimension of the interaction space 402. For example, suppose that the interaction space corresponds to a cone which extends out from the mobile device 104 in the direction of the user 102. The gesture calibration module 910 can include functionality that allows the user 102 to adjust the outward reach of the cone, as well as the width of the cone at its maximal reach. These commands can adjust the interaction space 402 in different ways depending on the manner in which the mobile device 104 and mount 302 establish the interaction space. In one case, these commands may adjust the region from which gestures are extracted from depth information, where that depth information is generated using any depth reconstruction technique. In another case, these commands may adjust the directionality of projectors that are used to create a region of increased brightness.

In another process, gesture calibration module 910 can adjust various parameters and/or settings which govern the operation of the gesture recognition engine 906. For example, the gesture calibration module 910 can adjust the level of sensitivity of the camera devices. This type of provision helps provide viable and consistent input information, particularly in the case of extreme lighting conditions, e.g., in those situations where the interior region 200 is very dark or very bright.

In another process, the gesture calibration module 910 can invite the user 102 to perform a series of test gestures. The gesture calibration module 910 can collect image information which captures these gestures, and use that image information to create or adjust the gesture-related profile of the user 102. In some implementations, the gesture calibration module 910 can perform this training procedure only in those circumstances in which a new user first activates the gesture-recognition mode. The gesture calibration module 910 can ascertain the identity of the user 102 because the mobile device 104 is owned by and associated with a particular user.

The gesture calibration module 910 can use any mechanism to perform the above-described tasks. For example, in one case, the gesture calibration module 910 presents a series of instructions to the user 102 in a wizard-type format which guides the user 102 throughout the set-up process.

The gesture recognition module 512 can also optionally include a mode detection module 912 for detecting the invocation of the gesture-recognition mode. More specifically, some applications can operate in two or more modes, such as a touch input mode, a voice-recognition mode, the gesture-recognition mode, etc. In this case, the mode detection module 912 activates the gesture-recognition mode.

The mode detection module 912 can use different environment-specific factors to determine whether to invoke the gesture- recognition mode. In one case, a user can expressly (e.g., manually) activate this mode by providing an appropriate instruction. Alternatively, or in addition, the mode detection module 912 can automatically invoke the gesture-recognition mode based on the vehicle state. For example, the mode detection module 912 can enable the gesture-recognition mode when the car is moving; when the car is parked or otherwise stationary, the mode detection module 912 may de-activate this mode, based on the presumption that the use can safely directly touch the mobile device 104. Again, these triggering scenarios are mentioned by way of illustration, not limitation.

The gesture recognition module 512 can also include a dynamic performance adjustment (DPA) module 914. The DPA module 914 dynamically adjusts one or more operational settings of the gesture recognition module 512 in an automatic or semi-automatic manner during the course of the operation of the gesture recognition module 512. The adjustment improves the ability of the gesture recognition module 512 to recognize gestures in the dynamically-changing conditions within the interior of the vehicle 106.

As one type of adjustment, the DPA module 914 can select a mode in which the gesture recognition module 512 operates. Without limitation, the mode can govern any of: a) whether original image information is used to recognize gestures; b) whether depth information is used to recognize gestures; c) whether both original image information and depth information are used to recognize gestures; d) the type of depth reconstruction technique that is used to generate depth information (if any); e) whether or not the interaction space is illuminated by the projector(s); f) a type of interaction space that is being used, and so on.

As another type of adjustment, the DPA module 914 can select one or more parameters which govern the receipt of image information by one or more camera devices. Without limitation, these parameters can control: a) the exposure associated with the image information; b) the gain associated with the image information; c) the contrast associated the image information; d) the spectrum of electromagnetic radiation detected by the camera devices, and so on.

As another type of adjustment, the DPA module 914 can select one or more parameters that govern the operation of the projector(s) that are used to illuminate the interaction space (if used). Without limitation, these parameters can control the intensity of the beams emitted by the projector(s).

These types of adjustments are mentioned by way of example, not limitation. Other implementations can make other types of modifications to the performance of the gesture recognition module 512. For example, in another case, the DPA module 914 can adjust the shape and/or size of the interaction space.

The DPA module 914 can base its analysis on various types of input information. For example, the DPA module 914 can receive any type of information which describes the current conditions in the interior region of the vehicle 106, such as the brightness level, etc. In addition, or alternatively, the DPA module 914 can receive information regarding the performance of the gesture recognition module 512, such as a metric which is based on the average confidence levels at which the gesture recognition module 512 is currently detecting gestures, and/or a metric which quantifies the extent to which the user is engaging in corrective action in conveying gestures to the gesture recognition module 512.

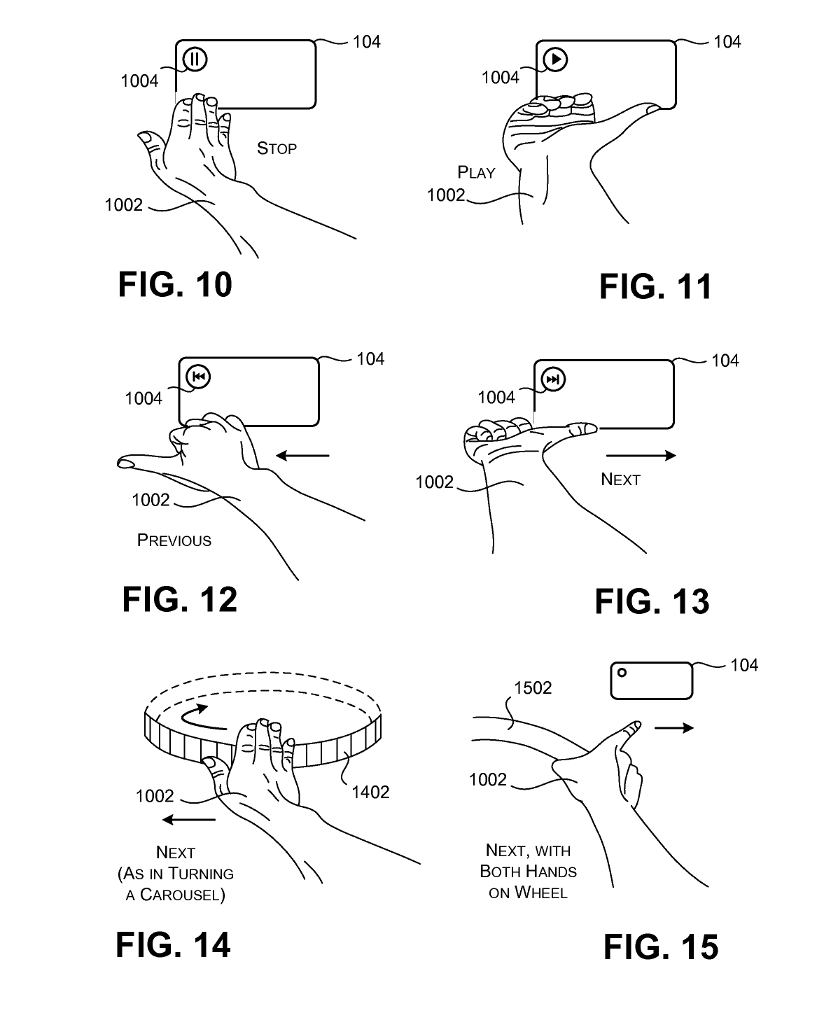

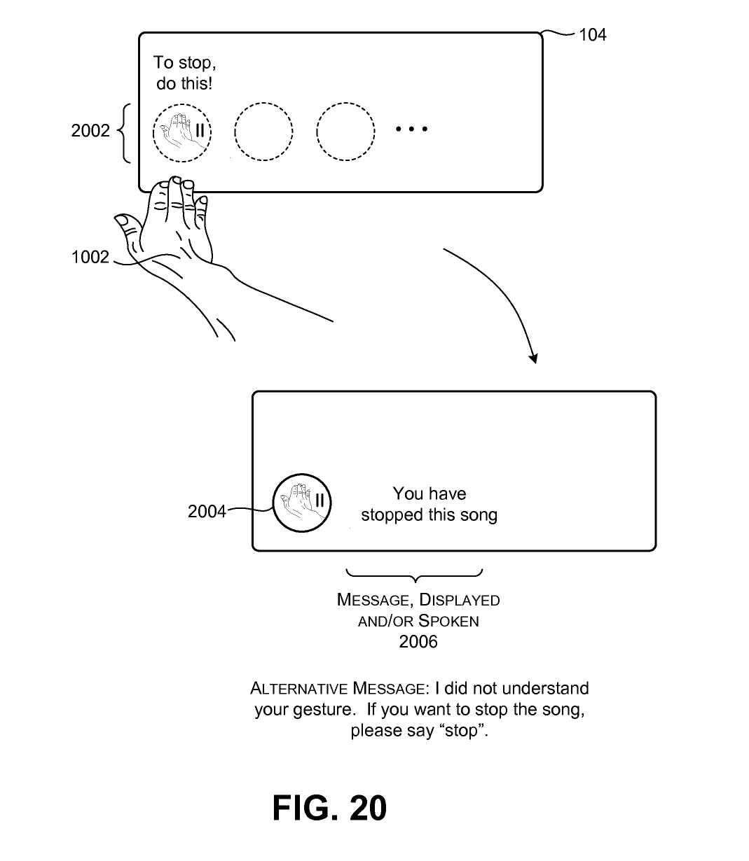

FIGS. 10-19 show illustrative gestures which invoke various actions (according to one non-limiting application environment). In each case, the user 102 is seated in the driver's seat of the vehicle 106. The user 102 uses his or her right hand 1002 to make a static and/or dynamic gesture within the interaction space 402. The mobile device 104 may optionally present feedback information 1004 on its device screen 602 which conveys to the user 102 the gesture that has been detected. As will be described with respect to FIG. 20, the mobile device 104 can also optionally present prompt information which informs the user 102 of the types of candidate gestures which he or she can make in a current juncture in the user's interaction with an application.

In FIG. 10, the user 102 extends his or her hand 1002 such that its palm generally faces the front surface of the mobile device 104. In one application environment, the mobile device 104 can interpret this gesture as a request to stop some activity, such as the playback of media content.

In FIG. 11, the user 102 places his or her hand 1002 such that the palm generally faces upward. The user 102 then folds his or her fingers towards his or her palm, as in performing a traditional “come here” command. In one application environment, the mobile device 104 can interpret this gesture as a request to start some activity, such as the playback of media content.

In FIG. 12, the user 102 extends the thumb of his or her right hand 1002 in a horizontal direction, pointed toward the left. Optionally, the user 102 can also dynamically move his or her right hand 1002 in this thumb-extended pose toward the left (in the direction of the arrow shown in FIG. 12). In one application environment, the mobile device 104 can interpret this gesture as a request to return to a previous item, such as by moving back to an earlier point in the presentation of media content. FIG. 13 depicts the complement of the gesture of FIG. 12; here, the mobile device 104 can interpret the gesture as a request to advance to a next item.

In FIG. 14, the user 102 extends his or her hand 1002 with the palm generally facing the surface of the mobile device 104 (like the case of FIG. 10). The user 102 then shifts the hand 1002 to the left or to the right. In one environment, the mobile device 104 interprets a leftward movement as a request to advance to a next item in a sequence of items. The mobile device 104 interprets a rightward movement as a request to advance to a previous item in the sequence of items. In other words, the sequence of items can be metaphorically viewed as being arranged on a carousel. The user's movement rotates the carousel to bring a previous or next item into principal focus. In one case, the mobile device 104 can also display a visual representation 1402 of a carousel-like arrangement of the sequence of items.

In FIG. 14, the user 102 lifts a finger of his or her right hand 1002, while otherwise maintaining a grip on the steering wheel 1502 of the vehicle 106. In one environment, the mobile device 104 interprets this movement as a request to advance to a next item because the user 102 has lifted a finger of the right hand 1002, not the left hand. The user 102 can advance to a previous item by lifting a finger of his or her left hand.

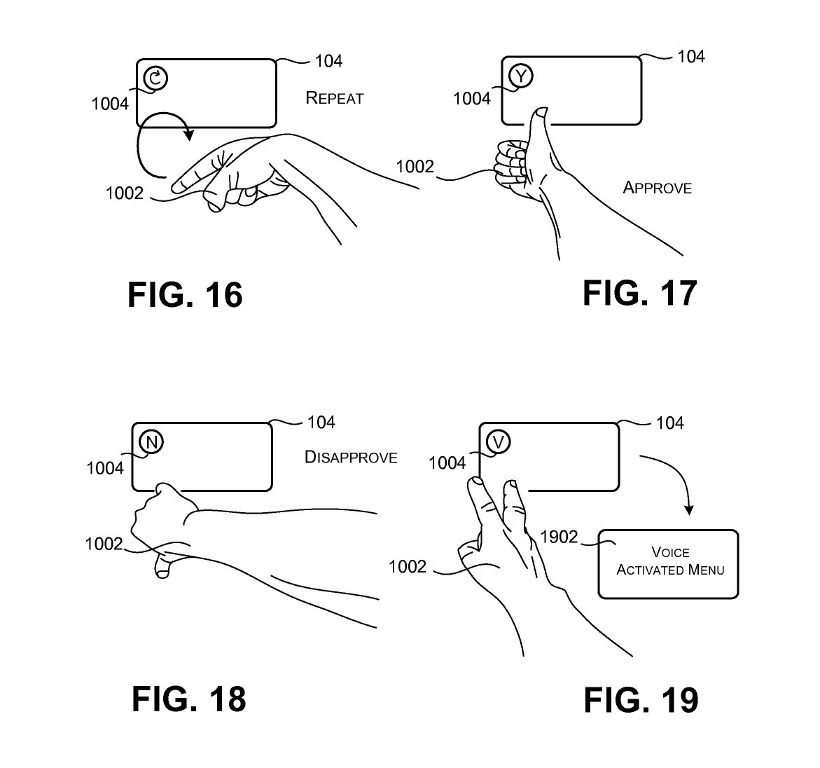

In FIG. 16, the user 102 extends the index finger of his or her right hand 1002. The user 102 then dynamically traces a circle with the index finger. In one environment, the mobile device 104 can interpret this gesture as a request to repeat some action, such as to repeat the playback of media content. This gesture is also an example of a type of gesture that resembles the traditional graphical symbol associated with the gesture. That is, a looping arrow is often used to graphically designate a repeat action. The gesture associated with this action traces out a path defined by the traditional symbol.

In FIG. 17, the user 102 extends a thumb of his or her right hand 1002 in the upward direction, as in giving a traditional “thumbs up” signal. In one environment, the mobile device 104 interprets this action as an indication that the user 102 has given approval to an action, option, item, issue, etc. Similarly, in FIG. 18, the user 102 extends a thumb of his or her right hand 1002 in the downward direction, as in giving a traditional “thumbs down” signal. In one environment, the mobile device 104 interprets this action as an indication that the user 102 has given disapproval of an action, option, item, issue, etc.

In FIG. 19, a user uses his or her right hand 1002 to give a traditional “V” signal. In one environment, the mobile device 1402 interprets this action as invoking a voice-recognition mode of the mobile device 104 (where “V” denotes the first letter of “voice”). For instance, as shown in FIG. 19, this gesture causes the mobile device 104 to display a user interface presentation 1902 which provides instructions and/or prompting information pertaining to the use of voice to control the mobile device 104.

FIG. 20 shows a user interface presentation that provides prompt information 2002. The prompt information 2002 identifies the set of candidate gestures that are recognizable by the mobile device 104 at the current juncture in the user's interaction with an application. The prompt information 2002 can convey each candidate gesture in the set of gestures in any manner. In one case, the prompt information 2002 can include a visual depiction of each legal gesture. In addition, or alternatively, the prompt information 2002 can provide textual instructions, as in “To stop, do this!” In addition, or alternatively, the prompt information 2002 can include symbolic information, such as the “H” symbol to designate a stop command. As stated above, a gesture can be chosen to statically and/or dynamically mimic some aspect of a traditional symbol associated with the gesture, as in the example of FIG. 16.

The mobile device 104 can also provide feedback information 2004 which indicates the gesture that has been recognized by the gesture recognition module 512. An action-taking module can also automatically perform the control action associated with the detected gesture—that is, providing that the gesture recognition module 512 is able to interpret the gesture with suitable confidence. The mobile device 104 can also optionally provide an audible and/or visual message 2006 which explains the action that has been taken.

Alternatively, the gesture recognition module 512 may be unable to determine the gesture that the user 102 has made with sufficient confidence. In this circumstance, the mobile device 104 can provide an audible and/or visual message which informs the user 102 that recognition has failed. The message may also instruct the user 102 to take remedial action, such as by repeating the gesture, or by combining the gesture with a vocal annunciation of the desired command, and so on.

In other cases, the gesture recognition module 512 can form a conclusion that the user 102 has made a certain gesture, but that conclusion does not have a high level of confidence associated therewith. In that scenario, the mobile device 104 can ask the user 102 to confirm the gesture that he or she has made, such as by providing the audible message, “If you want to stop the music, say ‘stop’ or make a stop gesture.”

In the examples presented so far, the user 102 has performed static and/or dynamic gestures using his or her hands. But, more generally, the gesture recognition module 512 can detect static and/or dynamic gestures made by the user 102 using any body part or combination of body parts. For example, the user 102 can convey gestures using head movement (and/or poses), shoulder movement (and/or poses), etc., in optional conjunction with hand movement (and/or poses).

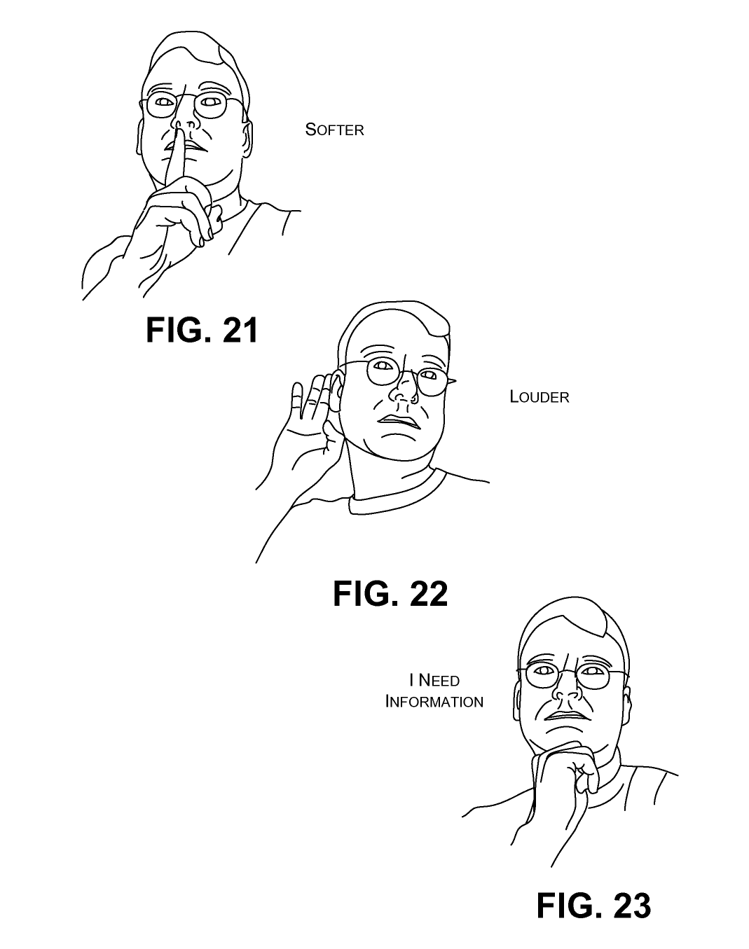

FIGS. 21-23, for instance, show three static gestures that the user 102 can make by touching his or her face with a hand. That is, in FIG. 21, the user 102 raises a finger to his or her lips to instruct the mobile device 104 to reduce the volume of its audio presentation. In FIG. 22, the user 102 places his or her fingers behind an ear to instruct the mobile device 104 to increase the volume of its audio presentation (as in a traditional “I cannot hear what you are saying” gesture). In FIG. 23, the user 102 pinches his or her chin between an index finger and thumb to create a quizzical pose; this may instruct the mobile device 104 to perform a search, retrieve a map, or perform some other information-finding function. In another possible hand-to-face gesture (not shown), the user 102 can make a movement that mimics placing a phone near an ear; this may instruct the mobile device 104 to initiate a call.

To repeat, the gestures described above are representative, rather than limiting. Other environments can adopt the use of additional gestures, and/or can omit the use of any of the gestures described above. Any choice of gestures can also take account of the conventions in a particular country or region, e.g., so as to avoid the use of gestures that may be considered offensive, and/or gestures that may confuse or distract other motorists (such as a gesture of waving in front of a window).

As a closing point, the above-described explanation has set forth the use of the gesture-recognition mode within vehicles. But the user 102 can use the gesture-recognition mode to interact with the mobile device 104 in any environment. The user 102 may find the gesture-recognition mode particularly useful in those scenarios in which the user's hands and/or focus of attention are occupied by other tasks (as when the user is cooking, exercising, etc.), or in those scenarios in which the user cannot readily reach the mobile device 104 (as when the use is in bed with the mobile device 104 on a night stand or the like).

B. Illustrative Processes

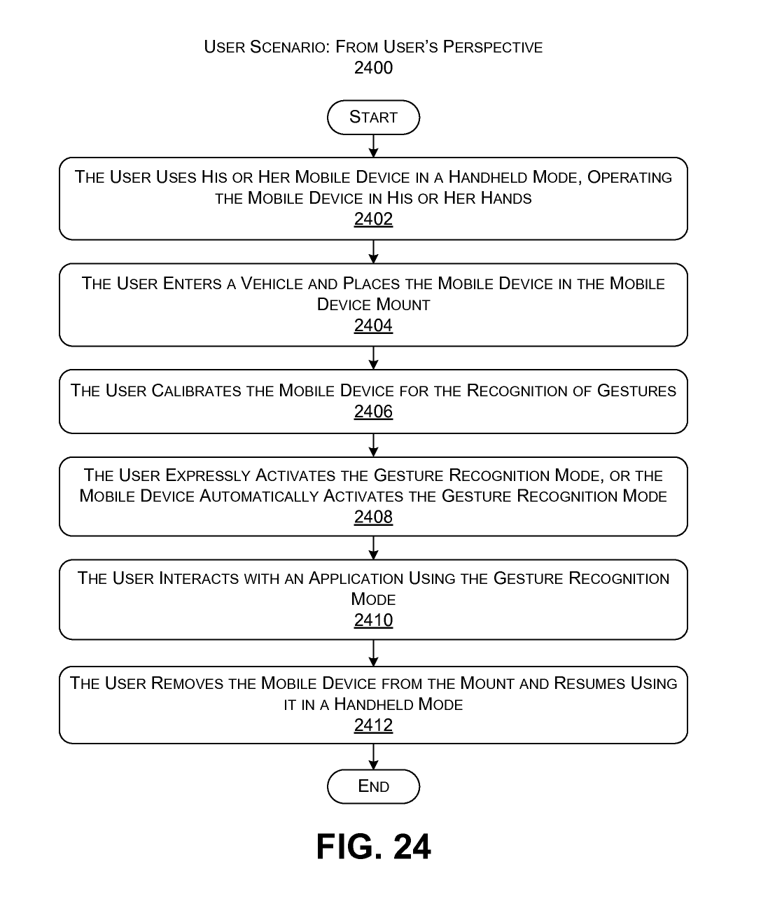

FIGS. 24-27 show procedures that explain one manner of operation of the environment 100 of FIG. 1. Since the principles underlying the operation of the environment 100 have already been described in Section A, certain operations will be addressed in summary fashion in this section.

Starting with FIG. 24, this figure shows an illustrative procedure 2400 that sets forth one manner of operation of the environment 100 of FIG. 1, from the perspective of the user 102. In block 2402, the user 102 may use his or her mobile device 104 in a conventional mode of operation, e.g., by using his or her hands to interact with the mobile device 104 using the touch input device 524. In block 2404, the user 102 enters the vehicle 106 and places the mobile device 104 in any type of mount, at an appropriate location and orientation within the interior region 200 of the vehicle 106. In block 2406, the user 102 calibrates the mobile device 104 to provide an appropriate interaction space 402 for the detection of gestures made by the user 102. In block 2408, the user 102 may expressly activate the gesture-recognition mode; alternatively, the mobile device 104 may automatically invoke the gesture-recognition mode based on one or more factors, such as based on operational state of the vehicle. In block 2410, the user 102 interacts with one or more applications in the gesture-recognition mode. That is, the user 102 issues commands to any application by making gestures. In block 2412, after completion of the user's trip, the user 102 may remove the mobile device 104 from the mount. The user 102 may then resume using the mobile device 104 in a normal handheld mode of operation.

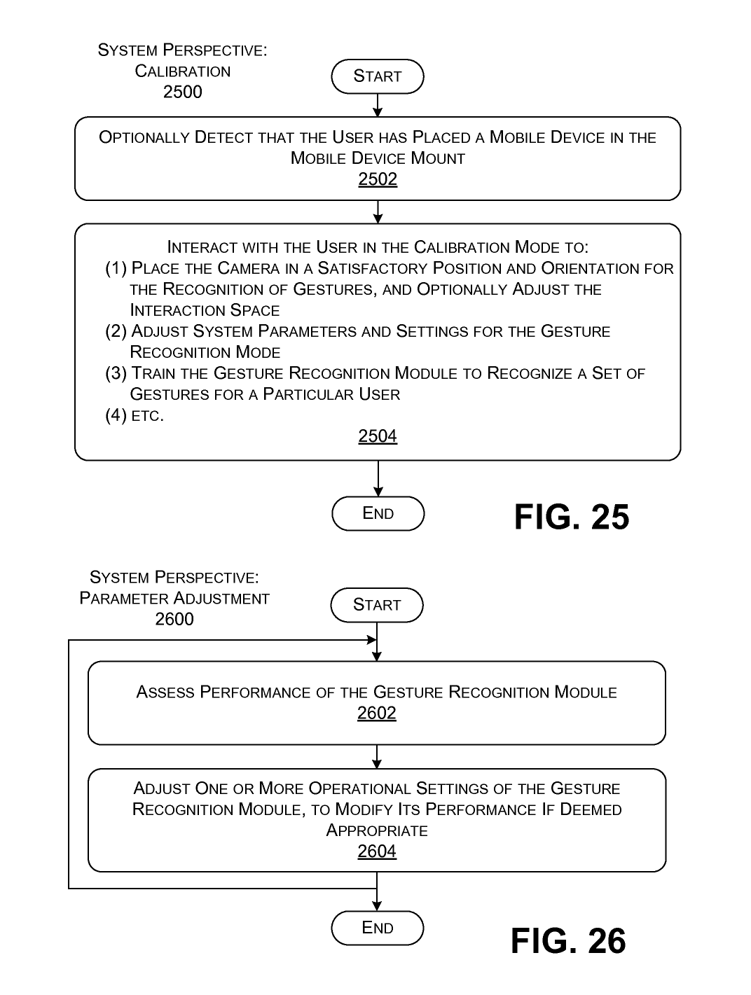

FIG. 25 shows an illustrative procedure 2500 by which a user can calibrate the mobile device 104 for use in the gesture-recognition mode, from the perspective of the gesture calibration module 910. In block 2502, the gesture calibration module 910 can optionally detect that the user 102 has inserted the mobile device 104 into a mount within the vehicle 106. Alternatively, the gesture calibration module 910 can invoke its calibration procedure in response to an express instruction from the user 102. In block 2504, the gesture calibration module 910 interacts with the user 102 to calibrate the mobile device 104. Calibration can include: (1) guiding the user 102 in the placement of the mobile device 104 and the establishment of the interaction space 402; (2) adjusting system parameters and/or settings for the gesture-recognition mode; (3) inviting the user 102 to perform a series of testing gestures for use in deriving a gesture-related profile for the user 102, and so on.

FIG. 26 shows an illustrative procedure 2600 that explains one manner of operation of the dynamic performance adjustment (DPA) module 914 of FIG. 9. In block 2602, the DPA module 914 can assess the current performance of the gesture recognition module 512, which may comprise assessing the operating environment of the gesture recognition module 512 and/or assessing the success level at which the gesture recognition module 512 is currently operating. In block 2604, the DPA module 914 adjusts one or more operational settings of the gesture recognition module 512 to modify the performance of the gesture recognition module 512, if deemed appropriate. The settings that can be adjusted include, but are not limited to: a) at least one parameter that affects the projection of electromagnetic radiation into the interaction space by at least one projector; b) at least one parameter that affects receipt of the image information by at least one camera device; and c) a mode of image capture used by the gesture recognition module 512 to recognize gestures, etc.

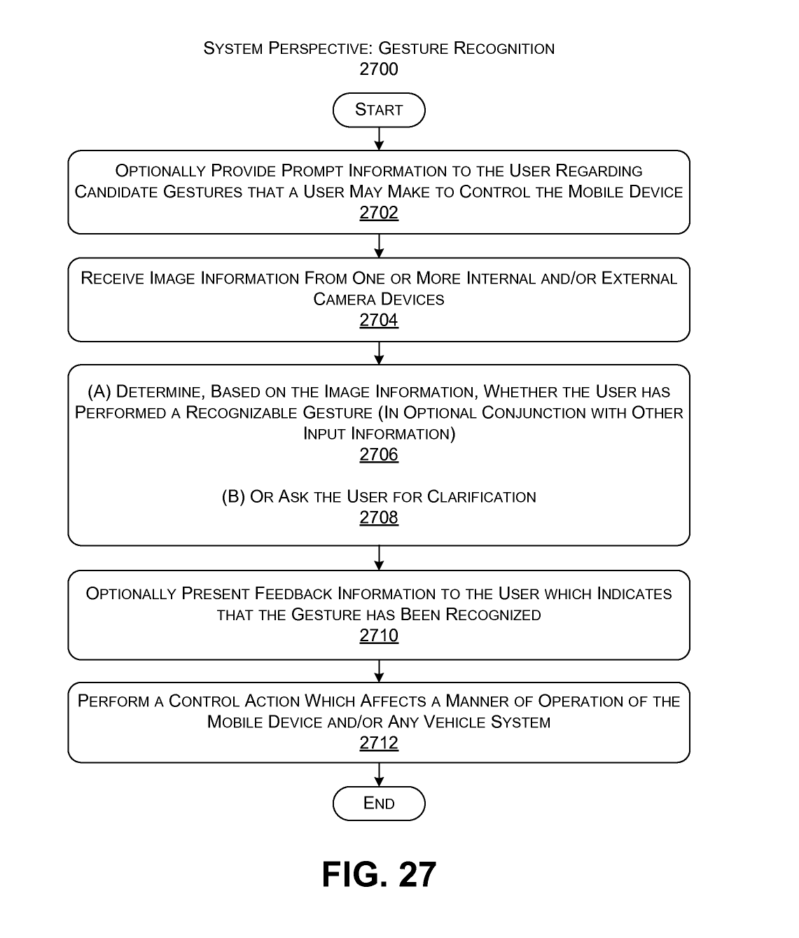

Finally, FIG. 27 shows an illustrative procedure 2700 by which the mobile device 104 can detect and respond to gestures. In block 2702, the mobile device 104 optionally provides prompt information which identifies candidate gestures that the user 102 may make to control an application in a current juncture in the use of that application. In block 2704, the mobile device 104 receives image information from one or more internal and/or external camera devices. As used herein, the general term image information encompasses original image information captured by one or more camera devices and/or any further-processed information that can be extracted from the original image information (such as depth information). The mobile device 104 can also receive other type of input information from other input devices. In block 2706, the mobile device 104 recognizes the gesture that the user 102 has made based on the input information. Alternatively, in block 2708, the mobile device 104 asks the user 102 to clarify the nature of the gesture that he or she has made. In block 2710, the mobile device 104 optionally presents feedback information to the user 102 which confirms the gesture that has been recognized. In block 2712, the mobile device 104 performs a control action associated with the gesture that has been detected. In an alternative implementation, the confirmation presented in block 2710 can follow block 2712, informing the user 102 of the action that has been performed.

C. Representative Computing functionality

FIG. 28 sets forth illustrative computing functionality 2800 that can be used to implement any aspect of the functions described above. For example, the type of computing functionality 2800 shown in FIG. 28 can be used to implement any aspect of the mobile device 104 and/or the mount 302. In addition, the type of computing functionality 2800 shown in FIG. 28 can be used to implement any aspect of the remote processing systems 118. In one case, the computing functionality 2800 may correspond to any type of computing device that includes one or more processing devices. In all cases, the computing functionality 2800 represents one or more physical and tangible processing mechanisms.

The computing functionality 2800 can include volatile and non-volatile memory, such as RAM 2802 and ROM 2804, as well as one or more processing devices 2806 (e.g., one or more CPUs, and/or one or more GPUs, etc.). The computing functionality 2800 also optionally includes various media devices 2808, such as a hard disk module, an optical disk module, and so forth. The computing functionality 2800 can perform various operations identified above when the processing device(s) 2806 executes instructions that are maintained by memory (e.g., RAM 2802, ROM 2804, or elsewhere).

More generally, instructions and other information can be stored on any computer readable medium 2810, including, but not limited to, static memory storage devices, magnetic storage devices, optical storage devices, and so on. The term computer readable medium also encompasses plural storage devices. In all cases, the computer readable medium 2810 represents some form of physical and tangible entity.

The computing functionality 2800 also includes an input/output module 2812 for receiving various inputs (via input modules 2814), and for providing various outputs (via output modules). One particular output mechanism may include a presentation module 2816 and an associated graphical user interface (GUI) 2818. The computing functionality 2800 can also include one or more network interfaces 2820 for exchanging data with other devices via one or more communication conduits 2822. One or more communication buses 2824 communicatively couple the above-described components together.

The communication conduit(s) 2822 can be implemented in any manner, e.g., by a local area network, a wide area network (e.g., the Internet), etc., or any combination thereof. As noted above in Section A, the communication conduit(s) 2822 can include any combination of hardwired links, wireless links, routers, gateway functionality, name servers, etc., governed by any protocol or combination of protocols.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In closing, functionality described herein can employ various mechanisms to ensure the privacy of user data maintained by the functionality. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have described various concepts in the context of illustrative challenges or problems. This manner of explanation does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for recognizing gestures using a mobile device that is mounted in a vehicle, the mobile device functioning as a handheld mobile device when not mounted in the vehicle, comprising:
receiving image information from at least one camera device,
the image information capturing a scene that includes an interaction space as part thereof, the interaction space comprising a volume having prescribed dimensions that projects out from the mobile device in a direction of a user who is operating the vehicle; and
determining, using a gesture recognition module, whether the user has performed a recognizable gesture within the interaction space, based on the image information,
wherein the gesture comprises one or more of: (a) a static pose made with at least one hand of the user without touching the mobile device; and (b) a dynamic movement made with said at least one hand of the user without touching the mobile device.

2. The method of claim 1, wherein said determining comprises:
generating depth information based on the image information using a depth reconstruction technique; and
extracting a representation of said at least one hand that is positioned within the interaction space, based on the depth information.

3. The method of claim 1, wherein said determining comprises:
projecting one or more beams of electromagnetic radiation, said one or more beams defining a region of increased relative illumination; and
extracting a representation of said at least one hand that is positioned within the interaction space by detecting an object having increased relative brightness in the image information.

4. The method of claim 1, wherein said at least one camera is a component of the mobile device.

5. The method of claim 1, wherein said at least one camera is a component of a mount that secures the mobile device within the vehicle.

6. The method of claim 1, wherein said receiving of image information is performed in conjunction with irradiating the interaction space with electromagnetic radiation, using at least one projector.

7. The method of claim 6, wherein said at least one projector is a component of the mobile device.

8. The method of claim 6, wherein said at least one projector is a component of a mount that secures the mobile device within the vehicle.

9. The method of claim 1, wherein said at least one camera device produces the image information in response to receipt of infrared spectrum radiation.

10. The method of claim 1, wherein said at least one camera device contains a bandpass filter that diminishes visible spectrum radiation.

11. The method of claim 1, further comprising defining the interaction space in a calibration procedure prior to said determining of the recognizable gesture.

12. The method of claim 1, further comprising:
assessing performance of the gesture recognition module, to provide an assessed performance; and
dynamically adjusting at least one operational setting of the gesture recognition module based on the assessed performance.

13. The method of claim 12, wherein said at least one operational setting is selected from:
at least one parameter that affects projection of electromagnetic radiation into the interaction space by at least one projector;
at least one parameter that affects receipt of the image information by said at least one camera device; and
a mode of image capture used by the gesture recognition module to recognize gestures.

14. The method of claim 1, further comprising performing a control action in response to determining that the user has performed the gesture, the control action affecting a manner of operation of the mobile device.

15. The method of claim 14, wherein the gesture is associated with a voice recognition mode, and wherein said performing of the control action comprises activating the voice recognition mode in response to determining that the user has performed the gesture.

16. A mobile device for use within a vehicle, comprising:
input functionality configured to receive image information regarding objects within a scene, the scene including, as part thereof, an interaction space, the interaction space projecting out a prescribed distance from the mobile device within the vehicle,
the image information originating from one or more of:
an internal camera device that is an internal component of the mobile device; and
an external camera device that is a component of a mount which secures the mobile device within the vehicle; and
the input functionality also including a gesture recognition module configured to determine whether a user has made a gesture within the interaction space, based on one or more of:
depth information that is generated from the image information using a depth reconstruction technique; and
the image information itself without consideration of the depth information,
wherein the gesture comprises one or more of: (a) a static pose made with at least one hand of the user without touching the mobile device; and (b) a dynamic movement made with said at least one hand of the user without touching the mobile device.

17. A mount for holding a mobile device, comprising:
a cradle for securing the mobile device; and
an imaging member including external camera functionality, the external camera functionality comprising:
at least one external camera device for receiving image information, the image information capturing a scene that includes an interaction space as part thereof, the interaction space comprising a volume having prescribed dimensions that projects out from the mobile device; and
an interface for providing the image information to input functionality provided by the mobile device.

18. The mount of claim 17, further comprising at least one projector for projecting electromagnetic radiation into the interaction space.

19. The mount of claim 17, further comprising image processing functionality for processing the image information.

20. The mount of claim 19, wherein the image processing functionality is configured to generate depth information based on the image information using a depth reconstruction technique.
